(19) United States
(12) Patent Application Publication
(10) Pub. No.: US 2016/0278301 A1
(43) Pub. Date: Sep. 29, 2016

(54) Garden Site and Enclosure

(71) Applicant: CUSTOM KEYHOLE GARDENS, LLC, EL SEGUNDO, CA (US)

(72) Inventor: William Smith, Camarillo, CA (US)

(21) Appl. No.: 14/670,252

(22) Filed: Mar. 26, 2015

(51) Int. Cl. A01G 9/02; C05G 3/00; C05G 3/04; A01G 1/08; C05F 11/00

(52) U.S. Cl. CPC A01G 9/02; A01G 1/08; C05F 11/00; C05G 3/04; C05G 3/0005

(57) ABSTRACT

A raised bed garden enclosure includes a cylindrical aspect and a walkway aspect leading to the center of the cylindrical aspect. The cylindrical aspect is formed of vertically disposed staves held together by a band around the outer surface of the cylindrical aspect of the enclosure.

### BACKGROUND

Studies have reported that home-grown fruits, vegetables, herbs, and the like, often have greater nutritional value than intensively farmed products of the same kind offered for sale at supermarkets. Additionally, artificial fertilizers and pesticides used in commercial products may have certain disadvantages, including possible deleterious health and environmental effects.

Accordingly, there has been steadily growing interest in home-cultivation of fruits, vegetables, herbs, and the like, using natural fertilizers and organic methods of pest and weed control.

Successful plant cultivation also is considered by many to have great instructional and educational value, permitting children and grown-ups alike to learn and experience firsthand how fruits and vegetables are produced, and the seasonal cycles of water, minerals, nutrients, life, death, and renewal that plant cultivation entails. These benefits are in addition to a personal fulfillment achieved when growing one's own food and knowing where it came from.

However all these goals cannot be achieved, and a backlash may occur, when gardening efforts fail. And fail they often do, particularly when soil and/or climate conditions are challenging.

Raised bed gardens have for long assisted gardeners control their growing environment, particularly the soil. A raised bed garden generally includes a structure that contains soil for cultivation at a level above the ground. Sturdier, more elevated raised bed structures can further provide certain ergonomic advantages, the most cited being that a gardener need not kneel when working the soil. Waist-high to chest-high raised bed structures permit a gardener to work while standing.

An African keyhole garden is a specific type of raised bed garden, having an upright, generally cylindrical peripheral wall section and a walkway wall section. The walkway section permits access to the central portion of the raised bed garden's cylindrical section. The walkway section generally leads to a structure resembling a vertically elongated cage. The cage resides in the center of the cylindrical section and serves as a receptacle for organic mulch. One of the characteristics of working African keyhole gardens is this cage that provides for in situ composting of organic mulch.

Keyhole garden walls are generally built from rock, bricks, cinderblocks or pavers. U.S. Patent App. Pub. No. 20130305602 teaches a stackable gardening container having a base made out of a monolithic body of a single material having a configuration with some characteristics common to an African keyhole-style garden set-up.

The in situ composting used in an African keyhole garden can generate a complex dynamic system. If not well tuned to its environment, in situ composting can deleteriously affect plant growth, rather than assist it. Accordingly it is not uncommon in these instances that the decorative aspects of a keyhole garden are used along with the lore of its use in Africa, but the in situ composting cage is removed to simplify the system to a point where an average gardener can successfully garden it using conventional means.

Accordingly, there is a need for a manner of forming an African keyhole-style raised bed garden that provides for a proper set-up permitting the consistent establishment of the complex dynamic system required for healthy plant growth. There is also a need for an African keyhole-style raised bed garden structure that, in addition to properly working, also is relatively easy and inexpensive to build and maintain, and has aesthetically pleasing characteristics.

The present invention provides an African keyhole-style gardening enclosure and method of construction which permits the establishment and maintenance of a soil ecosystem that in terms of water and fertilizer use, and other health and environmental concerns, efficiently assists healthy plant growth, increases garden production capacity, reduces the frequency of soil replacement while facilitating the task when it becomes necessary, and reduces the cost of construction of the garden over conventional constructions heretofore used.

### SUMMARY

In a first embodiment, a raised bed garden site includes an enclosure having a cylindrical aspect and a walkway aspect leading to the center of the cylindrical aspect. The cylindrical aspect is formed of vertically disposed staves held together by one or more bands around the outer surface of the cylindrical aspect of the enclosure. A silo is present in the enclosure for in situ processing of organic mulch.

In a second embodiment, a raised bed garden enclosure includes a cylindrical aspect and a walkway aspect leading to the center of the cylindrical aspect. The cylindrical aspect is formed of vertically disposed staves held together by one or more bands around the outer surface of the cylindrical aspect of the enclosure. A silo is present in the enclosure for in situ processing of organic mulch.

In a third embodiment, a transition connecting a cylindrical aspect to a walkway aspect of a raised bed garden enclosure using a post is disclosed.

In a fourth embodiment, a method of forming a raised bed garden enclosure having a cylindrical aspect and a walkway aspect leading to the center of the cylindrical aspect wherein the cylindrical aspect is formed of vertically disposed staves held together by a band around the outer surface of the cylindrical aspect of the enclosure is disclosed.

In a fifth embodiment, a kit for forming a raised bed garden site is disclosed.

In a sixth embodiment, a kit for forming a raised bed garden enclosure is disclosed.

In a seventh embodiment, prefabricated sections for forming a raised bed garden enclosure are disclosed.

In an eight embodiment, a growing medium for use with an enclosure having a silo for in situ processing of organic mulch is disclosed.

In a ninth embodiment, a method of forming a growing medium for use with an enclosure having a silo for in situ processing of organic mulch is disclosed.

### BRIEF DESCRIPTION OF THE DRAWINGS

Some non-limiting examples of the disclosed subject matter are illustrated in the following drawings. Identical or duplicate or equivalent or similar structures, elements, or parts that appear in one or more drawings are generally labeled with the same reference numeral, optionally with an additional letter or letters to distinguish between similar objects or variants of objects, and may not be repeatedly labeled and/or described. Dimensions of components and features shown in the figures are chosen for convenience or clarity of presentation. For convenience or clarity, some elements or structures are not shown or shown only partially and/or with different perspective or from different point of views.

FIG. 1 is a top view of a raised bed garden structure in accordance with an embodiment of the present invention.

FIG. 2 is a perspective view of a raised bed garden structure in accordance with an embodiment of the present invention.

FIG. 3 is a front view of a raised bed garden structure in accordance with an embodiment of the present invention.

FIG. 4 is an exploded diagrammatic illustration of the parts and construction of a raised bed garden site in accordance with an embodiment of the present invention.

FIG. 5 is a top view cross-section diagrammatic illustration of an alternate embodiment of the transition from cylindrical aspect to right lateral walkway aspect of an enclosure in accordance with an embodiment of the present invention.

FIG. 6 is an exploded diagrammatic illustration of the parts and construction of a growing medium for a raised bed garden in accordance with an embodiment of the present invention.

### DETAILED DESCRIPTION

A general non-limiting overview of practicing the present disclosure is presented below. The overview outlines exemplary practice of embodiments of the present disclosure, providing a constructive basis for variant and/or alternative and/or divergent examples, some of which are subsequently described.

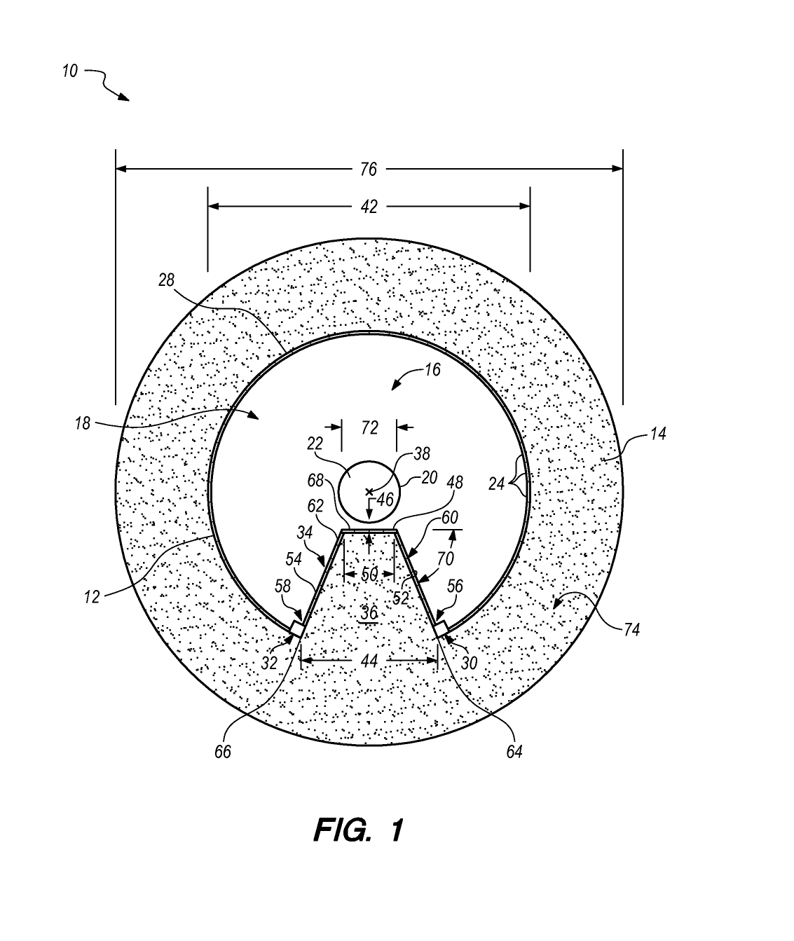

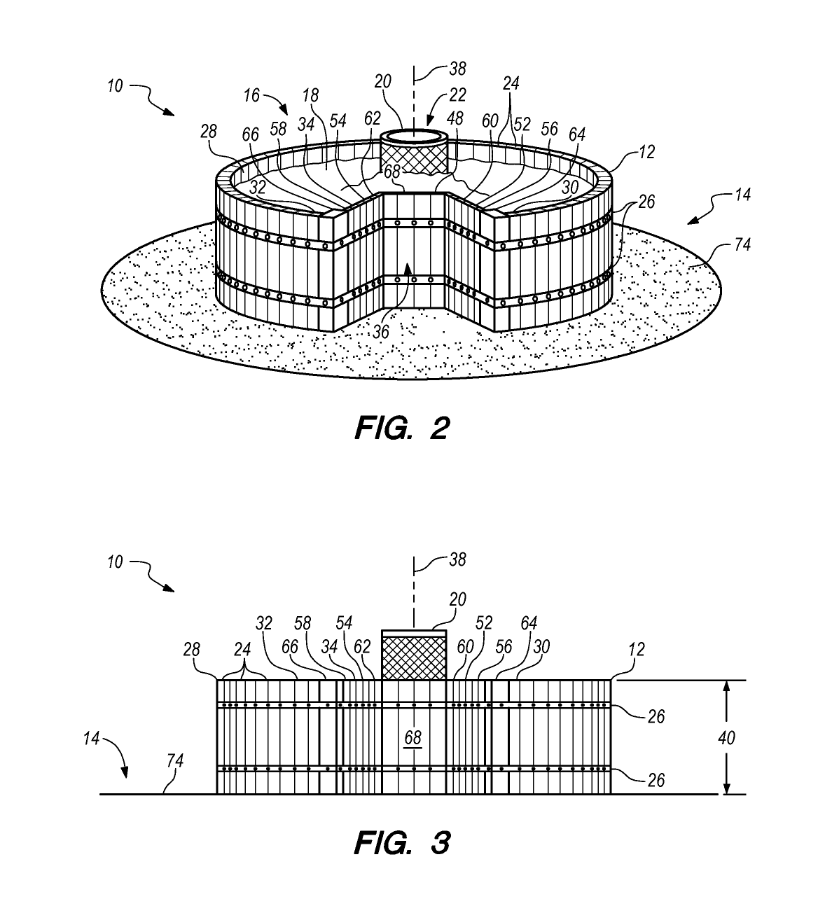

FIGS. 1-3 show a raised bed garden site 10 in accordance with an embodiment of the present invention. The raised bed garden site 10 includes an enclosure 12. The enclosure 12 is generally formed, built, assembled, or the like, (“formed”) on a horizontal, generally flat, gardening and gardener friendly surface 14. The enclosure 12 laterally encloses a gardening volume 16 for receiving a growing medium 18. A silo 20, basket, receptacle, or the like, is present within the gardening volume 16 for receiving and processing organic mulch 22 in situ.

The enclosure 12 may be built or assembled on any effective surface. The surface should be generally capable of sustaining the raised bed garden. The surface may also provide characteristics necessary to facilitate the successful cultivation of plants in the enclosure. The enclosure is generally formed from vertically disposed staves 24, held, fastened, bound, or the like, together, for example, by one or more bands 26, or as described herein.

The enclosure 12 generally has two aspects. A first aspect 28 includes a section of a vertically disposed hollow cylinder describing a circular arc of about 315 degrees, terminating on a right transition 30 and a left transition 32.

A second aspect 34 of the enclosure 12 provides a walkway 36 or corridor, and is formed by connecting the right 30 and left 32 transitions of the cylindrical aspect 28 of the enclosure 12 while projecting generally inwards, towards the axis 38, or central, portion of the cylindrical aspect 28 of the enclosure 12. The resulting enclosure 12 includes a shape similar to a vertically disposed indented hollow cylinder.

The enclosure 12 may be formed in any effective dimension. Generally the enclosure 12 may have a height 40 from about 1 foot to about 4 feet. In one embodiment, the height 40 of the enclosure 12 is about 2 feet. Generally the cylindrical aspect 28 of the enclosure 12 may have a diameter 42 from about 5 feet to about 7 feet. In one embodiment, the cylindrical aspect 28 of the enclosure 12 has a diameter 42 of about 6 feet. The walkway aspect 34 of the enclosure 12 should generally have a width 44 sufficient to accommodate the passage of a gardener. In one embodiment, for example, the walkway entrance width 44 measures about 2 feet. The walkway 36 formed by the enclosure 12 generally extends sufficiently into the cylindrical aspect 28 of the enclosure 12 such that a gardener can access the silo 20 at the center 38 of the cylindrical aspect 28 of the enclosure 12. A gap 46 generally is present between the end 48 of the walkway aspect 34 of the enclosure 12 and the near edge of the silo 20. In one embodiment, for example, the gap 46 measures about 6 inches. The width 50 at the end 48 of the walkway aspect 34 of the enclosure 12 should also accommodate a gardener. In one embodiment, for example, the width 50 of the end 48 of the walkway aspect 34 of the enclosure 12 measures about 1 foot.

In the embodiment shown, the walkway aspect 34 of the enclosure 12 is formed of three subsections. Right 52 and a left 54 walkway subsections start at right 56 and left 58 peripheral walkway transitions and project or extend inwardly generally towards the center 38 of the cylindrical aspect 28, ending in walkway medial right 60 and left 62 transitions respectively. Right 64 and left 66 walkway entrance posts connect right 56 and left 58 walkway peripheral transitions with right 30 and left 32 cylindrical aspect transitions, respectively. The third 68, or terminal, walkway subsection connects the medial right 60 and left 62 transitions, such that a generally continuous enclosure 12 is formed. The terminal walkway subsection meets with right 52 and a left 54 walkway subsections at an angle 70 of about 73 degrees.

As shown in the illustrated embodiment, the enclosure 12 may include structural elements for providing rigidity and or improving the longevity of the enclosure. For example, in the embodiment shown, right 64 and left 66 walkway entrance posts reinforce the junction between the right 30 and left 32 transitions of the cylindrical aspect 28 of the enclosure 12 and the right 56 and left 58 walkway peripheral transitions, respectively.

A silo 20, receptacle, or the like, for receiving and processing organic mulch 22, or the like, is generally present within the enclosure 12. The silo 20 may be formed in any effective manner, and may have any effective size and shape. In one embodiment, the silo 20 includes a perforated cylinder extending vertically from the lower portion of the center 38 of the enclosure 12. The silo 20 generally has a height that at least matches the height 40 of the enclosure 12, or that is above the planned or actual level for the growing medium 18. The height of the silo 20 should permit the easy placement of organic mulch 22 into the silo 20 by a gardener. In one embodiment, the silo 20 is cylindrical with a diameter 72 measuring about 12 inches. An adjacent surface 74 generally may surround the outside, or periphery, of the enclosure 12 such as to provide one or more individuals, e.g., gardeners, safe access to the growing medium 18. Other benefits of an adjacent surface 74 may include minimizing building costs, long term maintenance costs, and the like, and enhancing the aesthetic appeal of the garden. In one embodiment, the adjacent surface 74 surrounds the enclosure 12, extending for about 2 feet from the edge of the enclosure 12. For example, when the enclosure 12 has a diameter 42 of about 6 feet, the outer diameter 76 of the adjacent surface 74 may be about 10 feet.

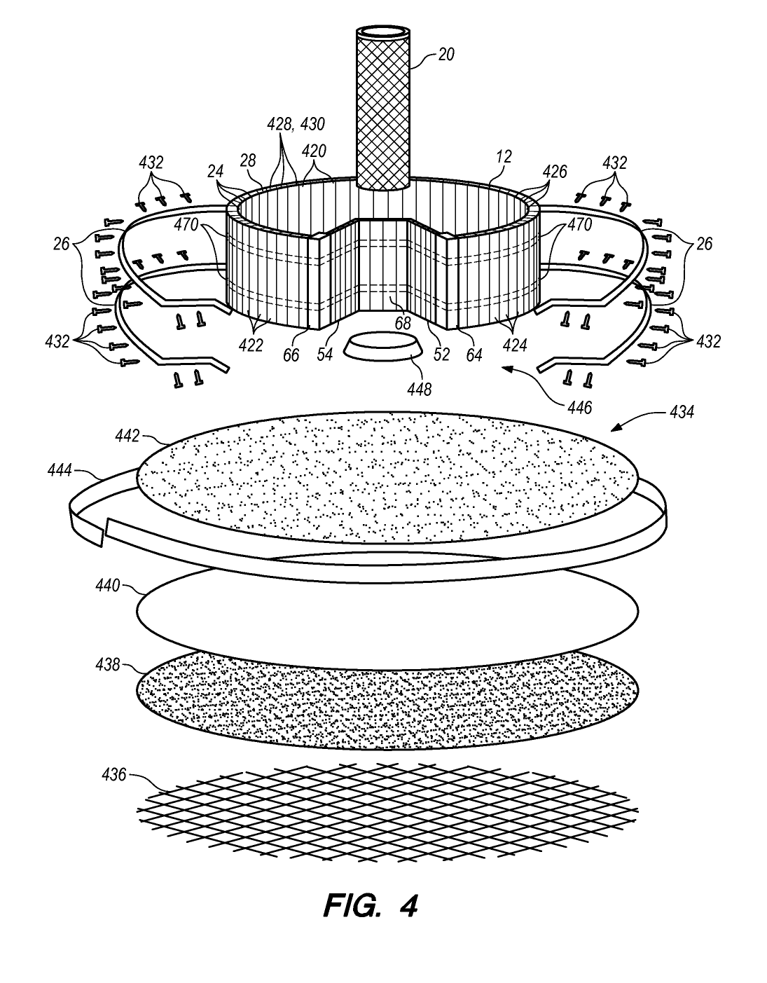

The garden site 10 may generally be formed in any effective manner. As shown in FIG. 4, for example, the enclosure is generally formed from vertically disposed staves 24. Each stave 24 generally includes inner and outer surfaces 420, 422, lower and upper surfaces 424, 426, and side surfaces 428, 430. Staves 24 are generally fastened side surface 428 of one stave 24 abutting side surface 430 of next stave 24, forming a desired enclosure 12 shape.

Staves 24 may generally be fastened in any effective manner. In the embodiment shown, one or more bands 26, loops, or the like, are fastened around the outside of the enclosure 12, such as to secure the staves 24, particularly those of the cylindrical aspect, in place. In one embodiment, the band 26 is fashioned from what is known in the trade as “1¼ metal band.” The band 26 may be fastened around the outside of the enclosure 12 in any effective manner. In one embodiment, the band 26 is directly fastened to one or more staves 24 with one or more fastening devices 432 such as nails, screws, bolts, glue, and the like. The resulting enclosure 12 can safely contain a growing medium and survive incidental forces that may be applied to the enclosure 12 during assembly and normal use.

Staves 24 should generally have the properties of being able to withstand forces that would normally be applied to them during use, being relatively weather resistant, inexpensive, aesthetically pleasing, and not known or suspected to have the potential to leach substances that may be deleterious to the growing medium, the plants, or humans that would consume the plants or plant products produced in or around the gardening structure. In one embodiment, the staves also have the property of assisting with beneficial cycles of temperature by providing insulation, and/or absorbing or reflecting energy from the sun. In one embodiment, the staves also have the property of assisting with beneficial management of water cycles involved in gardening, by providing: a) a wicking action when water or moisture levels are elevated with additional possible dissipation through the outside surface of the enclosure, b) a reservoir of water and humidity for the growing medium when water or moisture levels are decreasing, and c) as a barrier, buffer, or insulation, preventing moisture from the growing medium from laterally escaping when the conditions of the growing medium and/or atmosphere are relatively dry. In dry conditions, it was found that a plank of wood known in the trade as “untreated 2″×4″ pine” is surprisingly effective for the formation of staves for use in accordance herein.

The site 10 may include a ground cover 434. When present, a ground cover 434 may be formed in any effective manner. In the embodiment shown in FIG. 4, for example, a first ground cover layer 436 including a metal mesh, or the like, such as chicken wire, is laid on the ground, such as to protect the growing medium from burrowing fauna (e.g., pests) such as rodents and the like. A second ground cover layer 438 including a weed blocker, or the like, overlays the first ground cover layer 436. A third ground cover layer 440 that includes corrugated cardboard, or the like, overlays the second ground cover layer 438. A fourth ground cover layer 442 that includes rocks, or the like, overlays the third ground cover layer 440. In one embodiment, the fourth ground cover layer 442 includes what is known in the trade as 1″ pond rock.

In the embodiment shown, edging 444, or the like, surrounds the perimeter of the ground cover 434 such as to assist with the containment of one or more of the elements of the layers comprising the ground cover 434. In one embodiment, for example, what is known in the trade as 6″ plastic edging may be used.

In the embodiment shown, the ground cover 434 is circular, with a diameter sufficient to provide an area for the enclosure 12 and an area adjacent 74 to the enclosure 12. For example, if the diameter of the enclosure's cylindrical aspect 28 is around 6′, the diameter of the ground cover 434 may be around 10′.

An insulating surface 448, such as a ceramic disk, or the like, is present in the center 38 of the cylindrical section 28 of the enclosed area 446. The ceramic disk 448 is generally placed on the third ground cover layer 440, surrounded by rocks from the fourth ground cover layer 442 (detail not shown in the drawing figures). Ceramic disk 448 supports the silo 20.

One or more staves 24 may include markings, indicia 470, or the like, indicating location for fastening of bands 26 around enclosure 12, thus facilitating correct assembly.

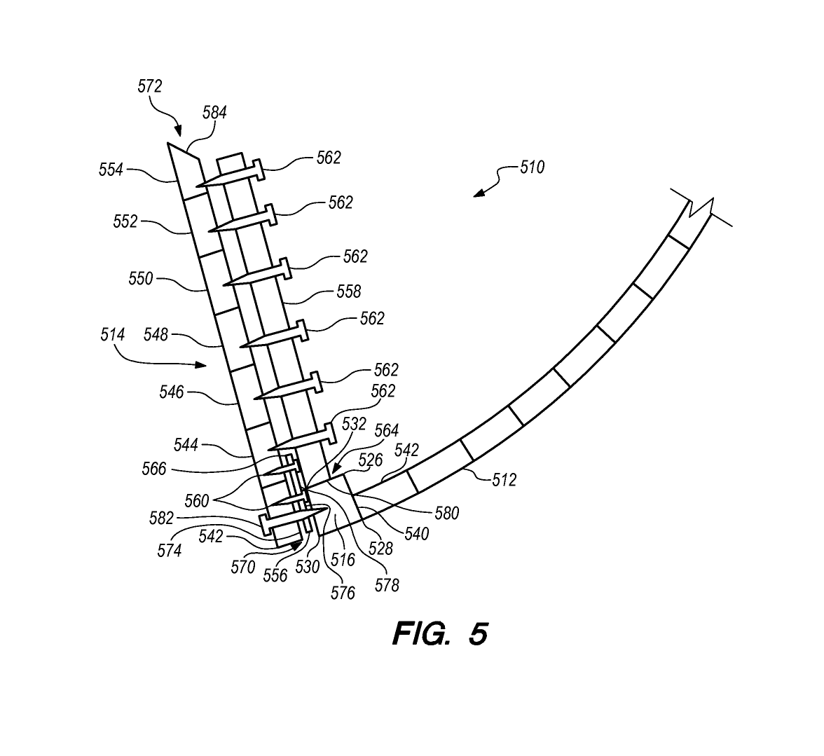

FIG. 5 is a diagrammatic top view cross-section illustration of an alternative construction of the transition 510 from a right cylindrical aspect 512 to a right lateral walkway aspect subsection 514 of an enclosure of the present invention using a post 516. (The left transition, not shown, is generally a symmetrical, mirror image.)

In the embodiment shown, post 516 is parallelepiped with four lateral surfaces 518, 520, 522, 524 forming a trapezoidal cross-section with interior angles 526, 528, 530, 532 of about 90, 90, 70, and 110 degrees, respectively. The post 516 may be formed in any effective manner. In one embodiment the post is formed by beveling a 4″×4″ (e.g., pine) lengthwise at an about 20 degree angle.

Side surface 540 of first stave 542 of right cylindrical aspect 512 meets lateral surface 518 of post 516. Right cylindrical aspect 512 is fastened to post 516 with a band, or the like (not shown, see, e.g., FIGS. 1-4, no. 26).

In the embodiment shown, lateral walkway subsection 514 includes seven staves 542, 544, 546, 548, 550, 552, 554 arranged side-to-side substantially linearly (forming a generally straight line as would be seen from above, or in cross-section). A set of straps 556, or the like, generally secures the most anterior, first stave 542 to the second stave 544, while a set of braces 558, or the like, generally secures the back six staves 544, 546, 548, 550, 552, 554 in place relative to each other.

Straps 556 are generally fastened to inner surface of first and second staves 542, 544 with a set of fastening devices 560, such as screws, or the like, e.g., two ¾ flat head screws 2½″ long. In one embodiment, for example, a set of two straps is used, one strap secured at about ¼ of stave height (see, e.g., FIG. 3, no. 40) measured from the upper surface of the staves and one strap secured at about ¼ of stave height measured from the lower surface of the staves. In one embodiment, straps 556 are a ¼″ wide, 7″ long 18 ga metal strap.

Braces 558 are generally fastened to inner surface of each of back-six staves 544, 546, 548, 550, 552, 554 with a set of fastening devices 562, such as screws, or the like, e.g., No. 10 deck screws, 2½″ long wood deck. In one embodiment, for example, a set of two braces is used, one brace secured at about ¼ of stave height measured from the upper surface of the staves and one brace secured at about ¼ of stave height measured from the lower surface of the staves. Braces 532 generally reinforce the enclosure when the assembly is complete. Braces 532 may be formed, for example, of pine 2″×4″×21″.

Anterior portion 564 of braces 558 sandwiches back portion 566 of straps 556 against staves 542, 544, such as to minimize exposure of growing medium to metal straps 556. Walkway lateral subsection 514 includes two interfaces: an anterior 570, or entrance, interface, and a posterior 572, or terminal, interface.

Anterior interface 570 includes the inner surface 574 of the first, or most anterior, stave 542, the inner surface 576 of the anterior portion 578 of the straps 556, and the anterior surface 580 of the braces 558, which surfaces 574, 576, 580 form a recess for receiving lateral surfaces 522, 524 of post 516. A set of fastening devices 582, e.g., No. 10 deck screw 2½″ long, secures the first stave 542 and straps 556 to surface 522 of post. Anterior surface 580 of braces 558 may be beveled to accommodate the angle of surface 524 of post 516.

The terminal interface 572 of the right lateral walkway aspect subsection 514 generally includes the side surface 584 of the most posterior stave 554, which stave surface 584 is beveled lengthwise at an about 15 degree angle, such as to generally match the angle at which the lateral subsection 514 meets a walkway terminal subsection (see, e.g., FIG. 1, no. 70).

In one embodiment the enclosure may be prefabricated, or provided for assembly with one or more prefabricated sections. The enclosure may be provided in any effective number of prefabricated sections. For example, the cylindrical aspect of the enclosure may be provided in one or more prefabricated sections, as may be the walkway aspect of the enclosure. A prefabricated section generally includes one or more staves, or the like, fastened to each other, and/or to a structural element, or the like. In one embodiment, the stave(s) and/or structural element(s) are fastened by a fastener that is easily removable during or after the assembly process.

A prefabricated section generally also includes one or more section assembly interfaces for easy fastening to other prefabricated sections, structural elements, or the like. A prefabricated section assembly interface generally includes one or more of a section's surfaces and may also include a fastening structure.

The prefabricated sections generally permit faster, easier, less labor intensive, higher quality, and more uniform assembly of the enclosure at the site where the enclosure is to be installed.

In one embodiment, a prefabricated section of the cylindrical aspect of the enclosure includes between about four and ten, preferably eight 2″×4″×2′ staves held in place or bound side-to-side. When eight 2″×4″ staves are used, seven said prefabricated sections are generally sufficient to form a 6′ diameter enclosure. The staves may be held in place in any effective manner. For example, in one embodiment one or more metal bands (assembly straps), preferably two metal bands spaced apart, are fastened to the inner surface of the staves, thus holding the staves in their relative places. In another embodiment, the staves are held or bound together with one or more panels of cardboard backing, or the like.

In one embodiment, a prefabricated section of the cylindrical aspect of the enclosure includes an interface for linking or connecting one prefabricated section to another element of the enclosure, e.g., another prefabricated section, a structural element, or the like. For example, a side surface of the stave that forms a side edge of a prefabricated section may generally serve as such an interface.

The interface may include a structure or device for fastening one prefabricated section to another prefabricated section, a structural element, or the like. For example, when staves of a prefabricated section are held or bound together by one or more metal bands, an extension of the metal bands past the edge of the prefabricated section may constitute such a fastening device or structure. Such an extension allows attachment of the prefabricated section to another prefabricated section, a structural element, or the like. Said extensions may be staggered such as to matingly engage with other prefabricated sections interfaces for easy assembly of sections to each other.

The interface may include a surface, structure, or device to receive a fastening structure or device from another prefabricated section, structural element, or the like. For example, in the case where a fastening device or structure is an extension of metal bands past the edge of a prefabricated section, a simple surface on a prefabricated section that allows attachment of the metal band extensions may constitute such an interface to receive a fastening structure or device from another prefabricated section, structural element, or the like.

Prefabricated lateral (right and left) subsections of the walkway aspect of the enclosure may be formed as generally illustrated and described in connection with FIG. 5. The lateral walkway subsections are generally symmetrical mirror images, and include, depending on the embodiment, between about five and eight, but generally six 2″×4″×2′ staves arranged side-to-side linearly (forming a generally straight line as would be seen from above, or in cross section).

In one embodiment, a prefabricated section of the terminal subsection of the walkway aspect of the enclosure includes between about three and five, preferably four 2″×4″×2′ staves arranged side-to-side linearly (forming a generally straight line as would be seen from above, or in cross section). The staves are generally secured in place relative to each other by one or more braces. For example, one 2″×4″ brace long enough to hold all the staves of the prefabricated section may be used. The brace is generally fastened or attached to the inner surface of the staves with a set of fastening devices, e.g., screws, or the like, at about ½ the height of the staves. The brace generally holds the staves in place relative to each other and reinforces the enclosure when the assembly is complete.

The enclosure may be assembled in any effective manner. In one embodiment, starting with a flat ground surface, chicken wire is unrolled and sectioned to cover a square having sides measuring 10½ ft., overlapping each section and staking the ends to stay in place. Weed block blackout material is then placed such as to cover the top of the wire layer. Three layers of cardboard are placed such as to cover the square area. A 3 ft. rod is inserted securely and square, 90 degrees to the ground surface, in the center of the square area, leaving approximately 1½ ft. of the rod above the top of cardboard. A piece of string, or the like, is installed on the center rod, and is used to draw a 12 in. diameter circle, a 6 ft. diameter circle and a 10 ft. diameter circle on the cardboard surface around the rod.

Prefabricated walkway aspect lateral subsections are assembled to the terminal subsection. This may be accomplished using two 2 ft. spacing braces to secure the posts in the correct geometry and properly spaced from each other. The spacing braces are attached to the posts loose at first keeping the braces to the outside and the plain side in. The posterior side surface of last stave of prefabricated right and left lateral subsections of walkway aspect are then fastened to the terminal subsection on the top, center, and bottom e.g., with 2½ in. deck screws.

The walkway assembly is installed in the desired position on the 6 ft. diameter circle. A prefab cylindrical section is fastened to the post on either the right or left lateral walkway subsection, e.g., with ¾ no. 10 screws, keeping the assembly straps tight to the post and with the assembly straps to the inside and on the 6 ft. diameter line. The remaining prefab cylindrical sections are then assembled keeping the staggered assembly strap side on the 6 ft. diameter circle. Keep each section tight and square to each other when fastening the staggered assembly strap ends. Proceed to assemble these sections around the 6 ft. diameter circle to the last opposite post. A ratchet strap is then placed around the outside of the enclosure securing it at the top by ratcheting it snug rather than tight. Another ratchet strap is similarly placed around the outside bottom of the enclosure. Both straps are then ratcheted evenly and slowly, top and bottom (e.g., 3 ratchets top, 3 ratchets bottom etc.) until all the gaps between the staves are tight, e.g., with no light coming thru, but without over tightening. The inside diameter of the enclosure should be on the 6 ft diameter circle drawn on the cardboard.

If indicia or placement markings for the bands are not already present, indicia are made indicating proper placement of bands around staves forming enclosure. For example, if the staves are about 2 ft. tall, and two bands are to be applied, indicia are made marking 6 in. down from the top in several places around the outside of the enclosure and 6 in. up from the bottom of the outside of the enclosure.

The starting end of a roll of 1¼ band of sufficient length is bent to about 90 degrees at about the ⅜ in. to ½ in. mark, lengthwise. The bent end is inserted in alignment with the band on the outer surface of terminal walkway subsection, in the joint between the lateral and terminal subsections such that the remaining length of the roll is on the outside of the walkway. The band is fastened 6 in. from the top of the enclosure to the top of the band, e.g., with ¾ in. no. 10 flathead wood screws, all the way around the enclosure to the opposite side lateral walkway subsection.

Excess material is trimmed off the band leaving enough material for a 90 degree ⅜ in. to ½ in. long bend for a nice tight fit. The same procedure is done for the bottom band 6 in. up from the bottom of the enclosure to the bottom of the strap. Once the bands are assembled in place and secured, the top and bottom ratchet straps are removed, the top and bottom spacing braces at the front of walkway are removed, and the assembly straps from inside surface of the enclosure are removed.

Layers of cardboard, generally about 3 in number, are fit on the inside walls of the enclosure, 6 in. from top to bottom. Layers of cardboard, generally about 3 in number, are fit between the brackets, front and back, on inside walkway walls, 6 in. from top. The rod is removed from the center of enclosure. A potting plate, or the like, e.g., a 12 in. potting plate, is placed upside down over 12 in. diameter circle. A screen and wire are used to form a silo stack. The silo stack is placed on top of the potting plate, with the plate inside the silo stack's screen, such as to keep the bottom of screen round in shape.

Cut the 10 ft. diameter circle (chicken wire, weed block, and cardboard). Assemble the outside edging around the 12 ft. diameter.

In another embodiment, a kit is provided. A kit in accordance with the present invention generally assists with assembling an enclosure of the present invention, or, alternatively, a garden site of the present invention.

In one embodiment, the kit generally includes a set of instructions for assembling an enclosure, or, alternatively, a garden site, or portion thereof, as generally taught herein.

The kit may include one or more sets of items that may be used in assembling a garden or garden enclosure of the present invention.

Unless otherwise required by the context, as used herein a “set of items” generally includes one or more units of an item, and generally at least as many units as necessary for completing the job intended for that set of the item.

In one embodiment, for example, the kit comprises, consists of, or consists essentially of, a set of staves for building the cylindrical aspect of the enclosure, prefabricated lateral (right and left) subsections of the walkway aspect, a prefabricated terminal subsection of the walkway aspect of the enclosure, a set of bands, and sets of fastening devices to assemble an enclosure of the present invention. In another embodiment, for example, the kit comprises, consists of, or consists essentially of, a set of prefabricated cylindrical aspect sections for building the cylindrical aspect of the enclosure, prefabricated lateral (right and left) subsections of the walkway aspect, a prefabricated terminal subsection of the walkway aspect of the enclosure, a set of bands, and sets of fastening devices to assemble an enclosure of the present invention. In another embodiment, a kit further comprises, consists of, or consists essentially of, a set of chicken wire, a set of weed blocker, a ceramic plate, and a roll of screen wire for a silo. In one embodiment, the one or more of the staves in the kit includes indicia or markings indicating location for fastening of bands around enclosure.

The enclosure generally contains a growing medium 18. The growing medium may be formed in any effective manner. For example, the growing medium may generally provide for minerals, nutrients, organic matter, Nitrogen, and other components to assist and facilitate the growth of plants while preferably minimizing the need for artificial fertilizers and watering. Soil organisms conducive to plant growth, including microorganisms, earthworms, and the like, may be added to growing medium 18.

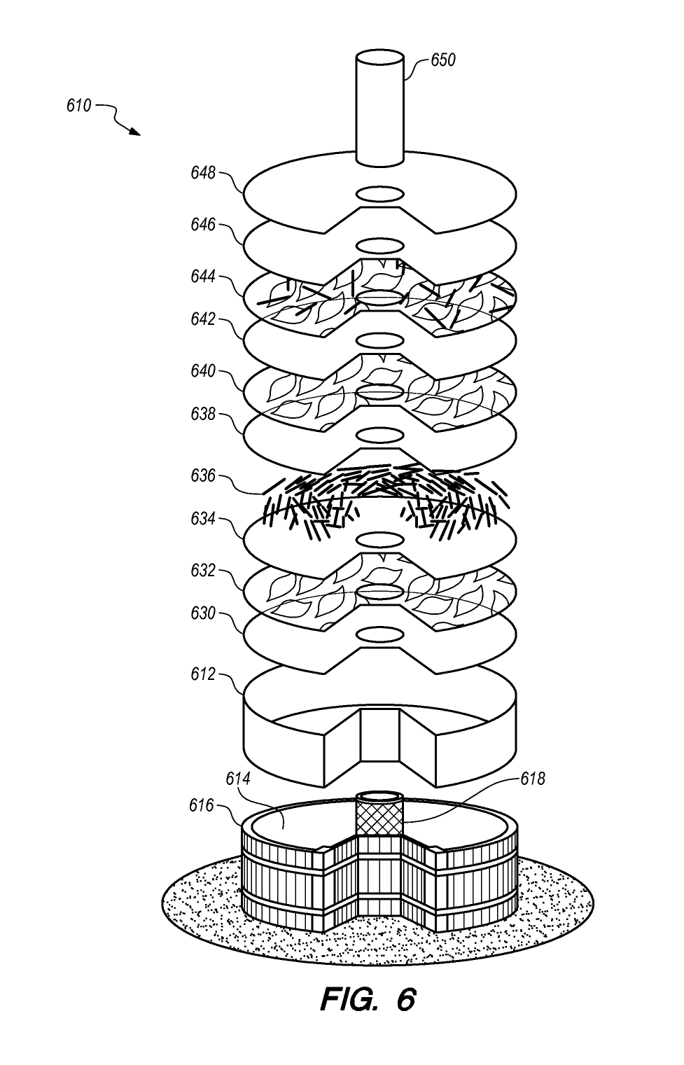

As illustrated in FIG. 6, in one embodiment a growing medium 610 is formed after initially lining 612 (e.g., with about three layers of cardboard, or the like) the interior surface 614 of an enclosure 616 and placing silo 618 in the enclosure 616. Starting from the bottom, alternating layers of corrugated cardboard, or the like, and vegetal organic matter, or the like, are placed inside the enclosure 616. For example, in the embodiment shown, a first growing medium layer 630 includes about 2 layers of corrugated cardboard, or the like, at the bottom of the enclosure. A second growing medium layer 632 includes green leaves (e.g., from plants or grass, but preferably not leaves from a citrus plant), or the like, spread evenly over the first growing medium layer 630. In one embodiment, the second layer has a thickness between about one and a half and two inches. A third growing medium layer 634 includes about 2 layers of corrugated cardboard, or the like, generally overlaying the second growing medium layer 632. A fourth growing medium layer 636 includes sticks, or the like, spread evenly over the third growing medium layer 634. In one embodiment, the fourth layer has a thickness between about one and a half and two inches. The sticks should generally be no longer than about an inch. The sticks are preferably layered in a circular pattern, following the curvature of the enclosure 616. A fifth growing medium layer 638 includes about 2 layers of corrugated cardboard, or the like, generally overlaying the fourth growing medium layer 636. A sixth growing medium layer 640 includes compressed dead dried leaves, or the like, spread evenly over the fifth growing medium layer 638. In one embodiment, the sixth layer has a thickness between about one and a half and two inches. A seventh growing medium layer 642 includes about 2 layers of corrugated cardboard, or the like, generally overlaying the sixth growing medium layer 640. An eighth growing medium layer 644 includes compressed yard waste (e.g., grass, weeds, plant trimmings), or the like, spread evenly over the seventh growing medium layer 642. In one embodiment, the eighth layer has a thickness between about one and a half and two inches. A ninth growing medium layer 646 includes about 2 layers of corrugated cardboard, or the like, generally overlaying the eight growing medium layer 644. A tenth growing medium layer 648 includes top soil, or the like, spread evenly over the ninth growing medium layer. In one embodiment, the tenth layer has a thickness of about twelve inches.

In use, after a site is formed with an enclosure, and a growing medium has been formed within the enclosure, mulch is added to silo stack and plants are planted in the growing medium.

While certain embodiments have been described, they have been presented by way of example only and are not intended to limit the scope of the inventions. Indeed, the novel methods, kits, and composites described herein may be embodied in a variety of other forms; furthermore, various omissions, substitutions, and changes in the form of the devices and methods described herein may be made without departing from the spirit of the inventions. The accompanying claims and their equivalents are intended to cover such forms or modifications as would fall within the scope and spirit of the inventions.

1. A raised bed garden site comprising:
an enclosure formed on a horizontal, flat surface, the enclosure comprising a cylindrical aspect and a walkway aspect;
a growing medium within the enclosure;
a silo for receiving and processing organic mulch in situ within the enclosure;
wherein the cylindrical aspect of the enclosure is formed from vertically disposed staves held together by one or more bands.

2. A raised bed garden enclosure comprising:
an enclosure comprising a cylindrical aspect and a walkway aspect;
a growing medium within the enclosure;
a silo for receiving and processing organic mulch in situ within the enclosure;
wherein the cylindrical aspect of the enclosure is formed from vertically disposed staves held together by one or more bands.

3. A growing medium comprising:
a first growing medium layer comprising about 2 layers of corrugated cardboard;
a second growing medium layer comprising green leaves spread evenly over the first growing medium layer, wherein the second layer has a thickness between about one and a half and two inches;
a third growing medium layer comprising about 2 layers of corrugated cardboard overlaying the second growing medium layer;
a fourth growing medium layer comprising sticks spread evenly over the third growing medium layer, wherein the fourth layer has a thickness between about one and a half and two inches;
a fifth growing medium layer comprising about 2 layers of corrugated cardboard overlaying the fourth growing medium layer;
a sixth growing medium layer comprising compressed dead dried leaves spread evenly over the fifth growing medium layer, wherein the sixth layer has a thickness between about one and a half and two inches;
a seventh growing medium layer comprising about 2 layers of corrugated cardboard overlaying the sixth growing medium layer;
an eighth growing medium layer comprising compressed yard waste spread evenly over the seventh growing medium layer, wherein the eighth layer has a thickness between about one and a half and two inches;
a ninth growing medium layer comprising about 2 layers of corrugated cardboard overlaying the eighth growing medium layer;
a tenth growing medium layer comprising top soil spread evenly over the ninth growing medium layer, wherein the tenth layer has a thickness of about twelve inches.
